(19) United States
(12) Patent Application Publication
(10) Pub. No.: US 2018/0349787 A1
(43) Pub. Date: Dec. 6, 2018

(54) ANALYZING COMMUNICATION AND DETERMINING ACCURACY OF ANALYSIS BASED ON SCHEDULING SIGNAL

(71) Applicant: Google Inc., Mountain View, CA (US)

(72) Inventors: Bryan Christopher Horling, Sunnyvale, CA (US); Ashutosh Shukla, Mountain View, CA (US); Paul Bunn, Mountain View, CA (US); Bo Pang, Sunnyvale, CA (US)

(21) Appl. No.: 14/316,643

(22) Filed: Jun. 26, 2014

(51) Int. Cl. G06N 99/00

(52) U.S. Cl. CPC G06N 99/005

(57) ABSTRACT

Methods, apparatus and computer-readable media (transitory and non-transitory) are disclosed for analyzing a communication to or from a user to identify an event assumption and/or determine a likelihood that the communication is event-related. In various implementations, an accuracy of the event assumption, as well as an accuracy of the determined likelihood, may be assessed based on one or more scheduling signals, such as user-creation of a corresponding calendar entry. In various implementations, a machine learning classifier may be trained based at least in part on one or both accuracies.

### BACKGROUND

Automatic extraction and/or determination of various information from communications to or from a user may help a user to be organized. For example, when a user receives an email from an airline with an itinerary, it may be helpful to the user if that itinerary is automatically extracted and corresponding entries are added to the user's calendar (or proposed to the user for addition to his or her calendar). It may also be helpful for that email to be automatically characterized, or “flagged,” as “event-related,” or perhaps more specifically as “travel-related” or even “airline-related.” When a format of such an email is known—which may be the case when an airline generates such emails automatically and on a large scale—the same technique may be used every time to extract the itinerary and/or flag the email as event-related. However, formats of such emails may change over time and/or between airlines. Additionally, the user may receive “informal” emails, e.g., dictated by human beings rather than automatically, with less predictable formats that make extraction of useful information more difficult. Determining how to better and more precisely extract information from and/or characterize communications may be difficult when, for reasons such as those relating to privacy and security, users wish to limit access to such communications.

### SUMMARY

This specification is directed generally to methods and apparatus for analyzing a communication to or from a user and determining an accuracy of the analysis based on one or more scheduling signals. In some implementations, a communication such as an email, text message, social networking post, instant message, voicemail (e.g., transcribed using speech recognition) may be analyzed to identify one or more event assumptions related to an event in which the user has participated, is participating, or will participate. Event assumptions may come in various forms, such as a location, time, date, invitees, participants, theme, purpose, etc. Event assumptions attributes may be compared to one or more scheduling signals (e.g., associated with or independent of the user) to determine an accuracy of the event assumptions. Additionally, the communication may be analyzed to determine a likelihood that the communication is a particular type of communication, such as “event-related.” Various “scheduling signals” may then be used to determine accuracy of the event assumptions and/or the determined likelihood. Scheduling signals may include but are not limited to creation of calendar entries, acceptance of proposed calendar entries, creation of tasks, creation of actionable items based on content of communications, setting or reminders, acceptance or rejection of appointments, and so forth.

In some implementations, a computer implemented method may be provided that includes the steps of: analyzing, by a computing system using a machine learning classifier, a communication to or from a user to identify an event assumption; determining, by the computing system based on one or more scheduling signals, an accuracy of the assumption; and training, by the computing system, the machine learning classifier based at least in part on the accuracy.

In some implementations, a computer-implemented method may be provided that includes the following operations: analyze a communication to or from a user to identify an event assumption; determine, based on one or more scheduling signals, an accuracy of the assumption; and update a method by which the communication is analyzed based at least in part on the accuracy.

In some implementations, a computer-implemented method may be provided that includes the following operations: analyze a communication to or from a user using a machine learning classifier to identify an event assumption; determine, based at least in part on the identified event assumption, a likelihood that the communication is event-related; determine, based on one or more scheduling signals, an accuracy of the determined likelihood; and train the machine learning classifier based at least in part on the accuracy.

These methods and other implementations of technology disclosed herein may each optionally include one or more of the following features.

In various implementations, the method may further include determining, by the computing system based at least in part on the event assumption and using the machine learning classifier, a likelihood that the communication is event-related. In various implementations, the method may further include determining, by the computing system, an accuracy of the determined likelihood that the communication is event-related. In various implementations, the method may further include determining, by the computing system based on a count of corroborative scheduling signals, an accuracy of the determined likelihood that the communication is event-related.

In various implementations, the one or more scheduling signals may include a calendar entry created by the user or by another sender or recipient of the communication. In various implementations, the one or more scheduling signals include an event reminder or task created for or by the user. In various implementations, the one or more scheduling signals include creation of one or more actionable items based on content of the communication. In various implementations, the one or more scheduling signals include acceptance or rejection of a candidate calendar entry proposed to the user.

In various implementations, the analyzing is performed by the computing system without providing any content of the communication to a human being.

Other implementations may include a non-transitory computer readable storage medium storing instructions executable by a processor to perform a method such as one or more of the methods described above. Yet another implementation may include a system including memory and one or more processors operable to execute instructions, stored in the memory, to perform a method such as one or more of the methods described above.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE DRAWINGS

FIG. 1 illustrates an example environment in which communications may be analyzed and in which the accuracy of that analysis may be determined.

FIG. 2 illustrates one example of how a communication may be analyzed and the accuracy of that analysis determined.

FIG. 3 is a flow chart illustrating an example method of analyzing communications to identify one or more event assumptions and to determine a likelihood that the communication is event-related, and determining accuracies of the assumptions and the likelihood.

FIG. 4 illustrates an example architecture of a computer system.

### DETAILED DESCRIPTION

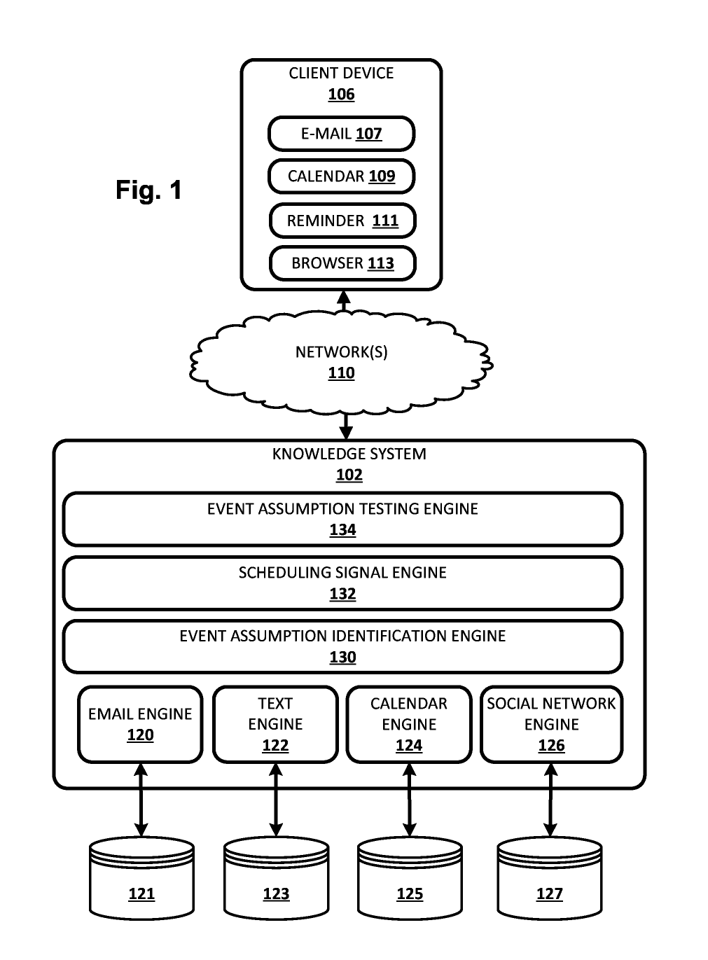

FIG. 1 illustrates an example environment in which communications to or from users may be analyzed to identify one or more event assumptions, to determine likelihoods that the communications are event-related, and in which accuracies of those event assumptions and determined likelihoods may be assessed. The example environment includes a client device 106 and a knowledge system 102. Knowledge system 102 may be implemented in one or more computers that communicate, for example, through a network (not depicted). Knowledge system 102 is an example of an information retrieval system in which the systems, components, and techniques described herein may be implemented and/or with which systems, components, and techniques described herein may interface.

A user may interact with knowledge system 102 via client device 106 and/or other computing systems (not shown). Client device 106 may be a computer coupled to the knowledge system 102 through one or more networks 110 such as a local area network (LAN) or wide area network (WAN) such as the Internet. The client device 106 may be, for example, a desktop computing device, a laptop computing device, a tablet computing device, a mobile phone computing device, a computing device of a vehicle of the user (e.g., an in-vehicle communications system, an in-vehicle entertainment system, an in-vehicle navigation system), or a wearable apparatus of the user that includes a computing device (e.g., a watch of the user having a computing device, glasses of the user having a computing device). Additional and/or alternative client devices may be provided. While the user likely will operate a plurality of computing devices, for the sake of brevity, examples described in this disclosure will focus on the user operating client device 106.

Client device 106 may operate one or more applications and/or components which may facilitate user consumption and manipulation of communications, as well as provide various types of scheduling signals. These application and/or components may include but are not limited to an email client 107, a calendar component 109 (which in some implementations may be a client, in others may be standalone, and in some cases may be integrated with email client 107), a reminder (and/or task) component 111, a browser 113, and so forth. In some implementations, browser 113 may be used as a de facto email and/or calendar client. In some instances, one or more of these applications and/or components may be operated on multiple client devices operated by the user. As used herein, a “communication” may include various types of communications to or from one or more users. Communications may include but are not limited to emails, email drafts, text messages, letters, voicemails (e.g., speech-recognized transcriptions thereof), blog postings, social networking postings/status updates/messages, instant messages, and so forth.

Client device 106 and knowledge system 102 each include one or more memories for storage of data and software applications, one or more processors for accessing data and executing applications, and other components that facilitate communication over a network. The operations performed by client device 106 and/or knowledge system 102 may be distributed across multiple computer systems. Knowledge system 102 may be implemented as, for example, computer programs running on one or more computers in one or more locations that are coupled to each other through a network.

In various implementations, knowledge system 102 may include an email engine 120, a text messaging engine 122, a calendar engine 124, a social network engine 126, an event assumption identification engine 130, a scheduling signal engine 132, and/or an event assumption testing engine 134. In some implementations one or more of engines 120, 122, 124, 126, 130, 132, and/or 134 may be omitted. In some implementations all or aspects of one or more of engines 120, 122, 124, 126, 130, 132, and/or 134 may be combined. In some implementations, one or more of engines 120, 122, 124, 126, 130, 132, and/or 134 may be implemented in a component that is separate from knowledge system 102. In some implementations, one or more of engines 120, 122, 124, 126, 130, 132, and/or 134, or any operative portion thereof, may be implemented in a component that is executed by client device 106.

Email engine 120 may maintain an index 121 of email correspondence between various users that may be available, in whole or in selective part, to various components of knowledge system 102. For instance, email engine 120 may include an email server, such as a simple mail transfer protocol (“SMTP”) server that operates to permit users to exchange email messages. In various implementations, email engine 120 may maintain, e.g., in index 121, one or more user mailboxes in which email correspondence is stored. Similar to email engine 120, text messaging engine 122 may maintain another index 123 that includes or facilitates access to one or more short message service (“SMS”) or multimedia messaging service (“MMS”) text messages exchanged between two or more users. While depicted as part of knowledge system 102 in FIG. 1, in various implementations, all or part of email engine 120, index 121 (e.g., one or more user mailboxes), text messaging engine 122 and/or index 123 may be implemented elsewhere, e.g., on client device 106.

Calendar engine 124 may be configured to maintain an index 125 of calendar entries and other scheduling-related information (e.g., tasks, reminders) associated with one or more users. In some implementations, calendar engine 124 may operate as a server, with calendar component 109 on client device acting as a client, although this is not required. For instance, users may operate and/or interact with calendar engine 124 using other mechanisms, such as browser 113. Social network engine 126 may maintain an index 127 of one or more status updates, social network messages, public posts, comments, and other communications made by a user on one or more social networks. While depicted as part of knowledge system 102 in FIG. 1, in various implementations, all or part of calendar engine 124 or social network engine 126, and/or their respective indices 125 and 127, may be implemented elsewhere, e.g., on client device 106. Additionally, the engines depicted in FIG. 1 are not meant to be exhaustive. Other engines not depicted in FIG. 1, such as an instant messaging engine or voicemail engine, may also be operated in cooperation with selected aspects of the present disclosure.

In this specification, the term “database” and “index” will be used broadly to refer to any collection of data. The data of the database and/or the index does not need to be structured in any particular way and it can be stored on storage devices in one or more geographic locations. Thus, for example, the indices 121, 123, 125, and/or 127 may include multiple collections of data, each of which may be organized and accessed differently.

In various implementations, event assumption identification engine 130 may be configured to obtain one or more communications, e.g., from one or more of email component 107, email engine 120, calendar component 109, text messaging engine 122, calendar engine 124, social network engine 126, or elsewhere, and may analyze the one or more communications to identify one or more event assumptions and/or determine (and in some instances provide as output) one or more likelihoods that the one or more communications are event-related. In some implementations, a likelihood that a communication is event-related may be represented as a probability, e.g., along a range and/or as a percentage. In some implementations, the likelihood may be binary, e.g., the communication is event-related or is not event-related.

Event assumption identification engine 130 may utilize various techniques to identify event assumptions and/or determine likelihoods that communications are event-related. These techniques include but are not limited to heuristics, regular expressions, machine learning, rules-based approaches, co-reference resolution, object completion, and so forth. In some implementations, event assumption identification engine 130 may include (or be implemented as) a machine learning classifier, e.g., configured to output data indicative of a likelihood that one or more communications are event-related.

In various implementations, event assumption identification engine 130 may additionally or alternatively use various metadata associated with a communication, such as sender, recipient, subject (e.g., containing the text “proposed meeting”), date sent, date received, and so forth, to identify one or more event assumptions and/or determine a likelihood that the communication is event-related. For example, if an email is from a user with the title “event coordinator,” then the email may be more likely to be event-related. In some instances, pieces of information contained in the email may also be more likely identified as event assumptions.

Suppose a user receives an email from a friend with the text, “Hi Bill, Jane is going to arrive at my house at 4:30 tomorrow afternoon. Can you arrive one half hour later?—Dan” Event assumption identification engine 130 may identify various event assumptions from this email. For example, event assumption identification engine 130 may resolve “tomorrow” as the day following the day the email was sent, which may be determined, for instance, based on metadata associated with the email. Event assumption identification engine 130 may also co-reference resolve “you” with “Bill,” since the email is addressed to “Bill.” Event assumption identification engine 130 may determine a scheduled arrival time for Bill—5:00 pm—based on a combination of Jane's arrival time (4:30), the word “afternoon” (which may lead event assumption identification engine 130 to infer “pm” over “am”), and the phrase “one half hour later.” Event assumption identification engine 130 may also infer a location—Dan's house—and may infer that Bill is requested to be there, from the word “arrive.” Depending on information available to event assumption identification engine 130—e.g., if it has access to an electronic contact list of Bill and/or Dan—event assumption identification engine 130 may further determine Dan's address.

Event assumption identification engine 130 may put all this together to identify event assumptions that the user “Bill” is supposed to be at Dan's house at 5:00 pm the day after the date the email was sent. Given these numerous event assumptions, event assumption identification engine 130 may also determine that it is highly likely that the email is event-related. By contrast, if less (or no) event assumptions were made based on a particular communication, event assumption identification engine 130 may determine that it is relatively unlikely that the communication is event-related.

In some instances, multiple communications may collectively form a conversation or thread that may include multiple event assumptions. For example, multiple users may propose and counter propose potential times or locations for a particular event. As these proposals and counter proposals converge in later communications, the event assumptions may be more likely to be correct. Accordingly, in various implementations, event assumptions determined, e.g., by event assumption identification engine 130, from communications that occur later in a thread or conversation may be more likely to be identified as event assumptions those that occur earlier in the thread or conversation.

Scheduling signal engine 132 may be configured to monitor various sources for scheduling signals that may corroborate or refute one or more event assumptions, as well as reflect on an accuracy of a determined likelihood that a communication is event-related. For instance, Scheduling signal engine 132 may monitor for scheduling signals that arise starting at the moment one or more event assumptions are identified and/or a likelihood that a communication is event-related is determined. In some instances, scheduling signal engine 132 may cease monitoring at the moment an event is assumed to take place. In other instances, scheduling signal engine 132 may continue monitoring after an event was assumed to take place.

In some implementations, scheduling signal engine 132 may provide some indication of these signals to various other components, such as event assumption testing engine 134, which may perform various actions with these scheduling signals (e.g., determining accuracies of one or more event assumptions or determined likelihoods that communications are event-related). In various implementations, scheduling signal engine 132 may monitor potential sources of scheduling signals, such as calendar engine 124 (or calendar 109 on client device 106), social network engine 126, reminder component 111, and so forth, to detect one or more instances of a user performing some scheduling action that corroborates (or refutes) an event assumption and/or a determined likelihood that a communication is event related. For instance, scheduling signal engine 132 may detect that a user created a calendar entry, and may provide data indicative of this calendar entry creation (e.g., including various features of the calendar entry such as its date, time, location, etc.) to other components, such as event assumption testing engine 134.

Event assumption testing engine 134 may be configured to compare one or more event assumptions, e.g., identified by event assumption identification engine 130, with one or more scheduling signals, e.g., detected by scheduling signal engine 132. Based on such comparisons, event assumption testing engine 134 may determine accuracies of those one or more event assumptions. An “accuracy” of an event assumption may be expressed in various ways. In some implementations, an assumption's accuracy may be expressed as a numeric or alphabetical value along a range, e.g., from zero to one or from “A+” to “F−.” In some implementations, an assumption's accuracy may be expressed in more absolute fashion, e.g., as positive (e.g., “true”) or negative (e.g., “false”). Event assumptions that are more positively corroborated may receive higher accuracy values, whereas event assumptions that are wholly or partially contradicted or otherwise negated may receive lower accuracy values.

Event assumption testing engine 134 may additionally or alternatively be configured to determine an accuracy of a likelihood, determined by event assumption identification engine 130, that a particular communication is event-related. In some implementations, event assumption testing engine 134 may determine such an accuracy based on corroboration of multiple event assumptions made based on a particular communication.

Suppose event assumption identification engine 130 determines that there is a relatively low likelihood that a particular communication is event related. However, suppose event assumption testing engine 134 determines that an event time, date and location assumed based on the particular communication were all accurate (e.g., a user create a calendar entry with all three). This may indicate that the likelihood determined by event assumption identification engine 130 was inaccurate.

As a contrasting example, suppose event assumption identification engine 130 determines that there is a relatively high likelihood that a particular communication is event related, and event assumption testing engine 134 determines that an event time, date and location assumed based on the particular communication were all accurate (e.g., a user creates a calendar entry with all three). This may indicate that the likelihood determined by event assumption identification engine 130 was accurate.

In implementations where event assumption identification engine 130 includes a machine learning classifier, event assumption testing engine 134 may provide, e.g., as training data to event assumption identification engine 130, feedback that is generated at least in part based on the accuracy of one or more event assumptions determined by event assumption testing engine 134, as well as the accuracy of one or more determined likelihoods that one or more communications are event-related. In some implementations, event assumption testing engine 134 may generate feedback that includes an indication of the accuracies itself, e.g., expressed as values in a range. Event assumption testing engine 134 may include other information in the feedback as well, including but not limited to content (e.g., patterns of text) in the document that lead to the event assumption being identified, annotations of the assumptions made, and so forth.

In implementations where event assumption identification engine 130 utilizes rules-based techniques, event assumption testing engine 134 may provide, e.g., to event assumption identification engine 130, feedback that is generated at least in part based on the accuracy and indicative of at least one applicable rule that was applied by event assumption identification engine 130 to identify the event assumption or to determine a likelihood that a communication was event-related. Event assumption identification engine 130 may then update, create, and/or modify one or more rules to adapt to the indicated accuracy.

In various implementations, assumptions and/or signals may be “daisy chained” across users to facilitate corroboration. For instance, suppose once again that a user A receives an email invite to an event hosted by user B. An event assumption may be identified, e.g., by event assumption identification engine 130, that A will be attending B's event. User A may send the invite to user C so that C may join A at B's event. In some instance, a second assumption may be identified, e.g., by event assumption identification engine 130, that C will also be at B's event, and that A will accompany C. C's subsequent creation of a calendar entry, or acceptance of a proposed candidate calendar entry, may then be used to corroborate the event assumption that A will be present at B's event, especially if that calendar entry includes A as an attendee.

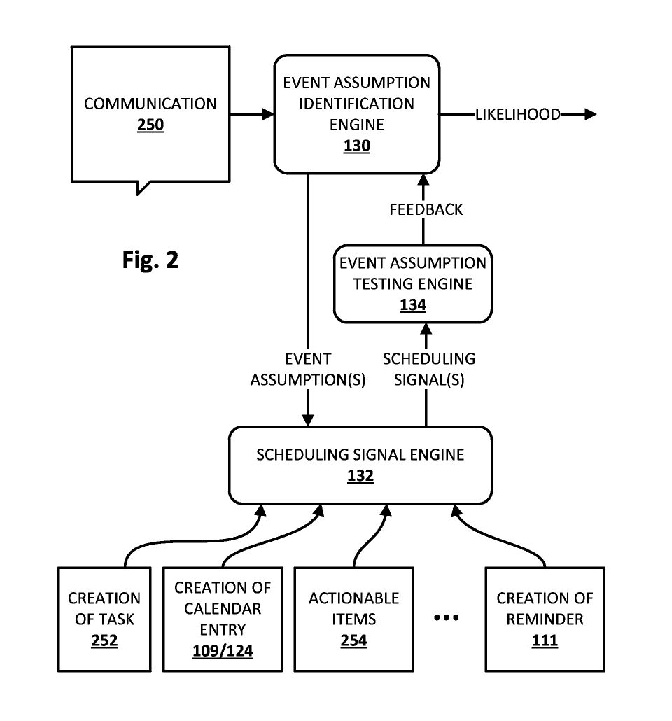

FIG. 2 schematically depicts one example of how a communication 250 may be analyzed by various components configured with selected aspects of the present disclosure to identify one or more event assumptions and/or determine a likelihood that a communication is event-related, as well as how accuracies of those one or more event assumptions or the determined likelihood may be assessed. As noted above, communication 250 may come in various forms, such as an email sent or received by the user, a text message sent or received by the user, and so forth. In various implementations, communication 250 may be processed by event assumption identification engine 130. In various implementations, event assumption identification engine 130 may output a likelihood or probability that communication 250 is event-related. While not shown in FIG. 2, in some implementations, one or more annotators may be employed, e.g., upstream of event assumption identification engine 130, e.g., to identify and annotate various types of grammatical information in communication 250. In such implementations, event assumption identification engine 130 may utilize these annotations to facilitate identification of one or more event assumptions.

In the implementation of FIG. 2, an event assumption may be identified, and/or a likelihood that a communication is event-related may be determined, by event assumption identification engine 130 based on content of communication 250 as well as characteristics of communication 250 (e.g., business versus personal), or metadata associated with communication 250. As noted above, event assumption identification engine 130 may use various techniques, including but not limited to heuristics, known text patterns, regular expressions, co-reference resolution, object identification, and so forth.

As noted previously, event assumption identification engine 130 may employ machine learning, e.g., a machine learning classifier, to identify event assumptions from communication 250 and/or to determine a likelihood that communication 250 is event-related. In such implementations, the machine learning classifier may be trained using feedback that is generated at least in part based on a determined accuracy of an event assumption or a determined likelihood that communication 250 is event-related. A relatively high level of accuracy may translate as positive training data for the classifier. A relatively low level of accuracy may translate as negative (or neutral) training data for the classifier.

Returning to FIG. 2, event assumption identification engine 130 may provide one or more event assumptions identified from communication 250 to scheduling signal engine 132. These event assumptions may be used by scheduling signal engine 132 to monitor for scheduling signals, such as creation of a task (252) by a user, creation of a calendar entry (109/124), or creation of a reminder (111), to determine accuracies of those assumptions. In various implementations, scheduling signal engine 132 may selectively monitor sources of scheduling signals that correspond with characteristics of communication 250 or event assumptions identified from communication 250. For example, if communication 250 is a social networking message, scheduling signal engine 132 may monitor closely activity at social network engine 126, e.g., to see if the user creates an entry in a calendar associated with her social networking profile. If an event assumption identified in communication 250 is annotated as a “due date,” then scheduling signal engine 132 may monitor for user creation of a task (252).

In some embodiments, scheduling signal engine 132 may utilize various actionable items 254 as scheduling signals. “Actionable items” may include various textual patterns commonly found in correspondence, such as dates (e.g., “MM/DD/YYYY”), phone numbers (e.g., “123-456-7890”), postal addresses, email addresses, websites, and so forth, that are identified and somehow emphasized to make them more conspicuous and/or interactive. For example, one or more words or phrases may be highlighted or even turned into, for instance, a link. A user may click on such a link to, for instance, create a calendar entry, create a new contact, dial a particular phone number, or compose an email to a particular recipient. Given the ubiquity of these textual patterns, there may be a relatively high degree of confidence that these patterns truly represent dates, phone numbers, addresses, websites, email addresses, etc. Thus, the act of creating an actionable item 254 based on one of these textual patterns may itself serve as a scheduling signal.

For instance, suppose event assumption identification engine 130 identifies, from an email, two event assumptions: that an event is occurring on a particular date, and that the event is occurring at a particular location. Then, suppose two textual segments of the email are independently converted into actionable items. One segment of text contains the particular date of the event and is converted into an actionable item that when clicked, opens an interface that enables a user to create a calendar entry on the same date. Another textual segment that contains the address of the event is turned into an actionable item that when clicked, opens an interface that enables real time navigation to the address. Creation of and/or existing of these actionable items may corroborate the two event assumptions identified by event assumption identification engine 130.

Upon detecting one or more scheduling signals, scheduling signal engine 132 may provide those scheduling signals to event assumption testing engine 134, as shown. Event assumption testing engine 134 may then compare those scheduling signals to one or more event assumptions identified by event assumption identification engine 130 to determine their accuracies. Event assumption testing engine 134 may additionally or alternatively determine an accuracy of a measure of likelihood, e.g., provided by event assumption identification engine 130 as output, that communication 250 is event-related. In some instance, event assumption testing engine 134 may determine the accuracy of such a likelihood based on one or more accuracies of one or more event assumptions.

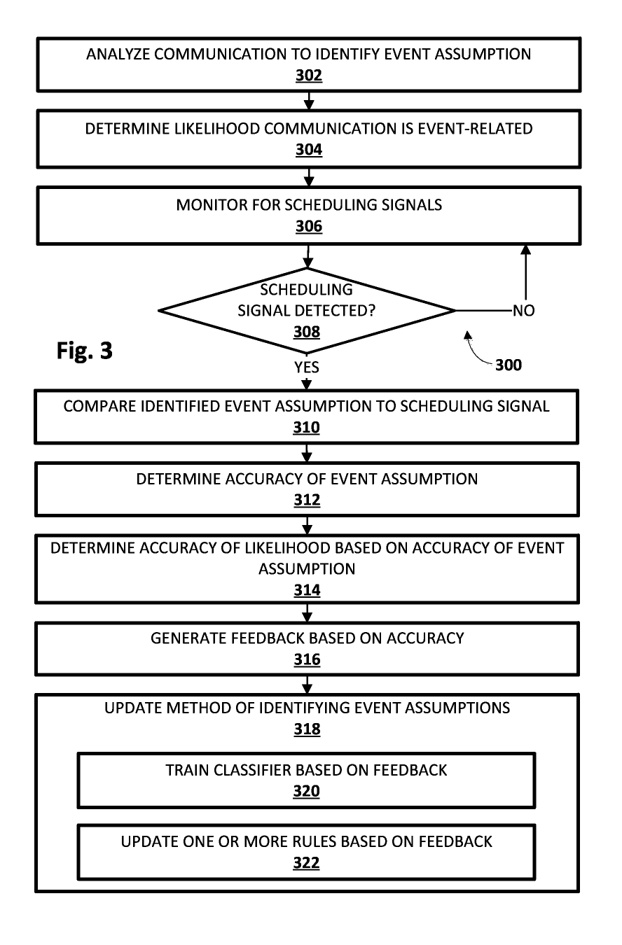

FIG. 3 schematically depicts an example method 300 of identifying event assumptions from communications and determining accuracies of those event assumptions. For convenience, the operations of the flow chart are described with reference to a system that performs the operations. This system may include various components of various computer systems. For instance, some operations may be performed at the client device 106, while other operations may be performed by one or more components of the knowledge system 102, such as email engine 120, text messaging engine 122, calendar engine 124, social network engine 126, event assumption identification engine 130, scheduling signal engine 132, event assumption testing engine 134, and so forth. Moreover, while operations of method 300 are shown in a particular order, this is not meant to be limiting. One or more operations may be reordered, omitted or added.

At block 302, the system may analyze a communication, such as an email sent or received by the user, to identify an event assumption (or multiple event assumptions). At block 304, the system may determine a likelihood that the communication analyzed at block 302 is event-related. In some implementations, the system may determine this likelihood based at least in part on the one or more event assumptions identified at block 302. Suppose analysis of a first communication yields only an event location, whereas analysis of a second communication yields an event date, time, location, and one or more invitees. Given that there were more event assumptions made about the second communication than the first, the system may determine that the second communication has a higher likelihood of being event-related than the first.

At block 306, the system may monitor, e.g., by way of scheduling signal engine 132, for one or more scheduling signals against which the event assumption may be corroborated (or refuted). For example, suppose the event assumptions are that a user will be at a location at a particular date and at a particular time. One scheduling signal that may be monitored as potentially corroborative is a calendar entry created by the user after the user received the communication, but before the assumed date and time of the event. Another scheduling signal that may be monitored as potentially corroborative is user creation of a task or reminder.

If, at block 308, no scheduling event is detected, then method 300 may return to block 306. However, if at block 308, a scheduling signal is detected, then at block 310, the event assumption identified at block 302 may be compared to the scheduling signal. At block 312, based on the comparison at block 310, the system may determine an accuracy of the event assumption.

At block 314, the system may determine an accuracy of the likelihood, determined by the system at block 304, that the communication is event-related. In various implementations, this determination may be based at least in part on the accuracy of one or more event assumptions determined at block 312. In some implementations, determining this accuracy may be based at least in part on a count of corroborative scheduling signals. For example, if a communication is deemed 60% likely to be event-related, but event assumptions of time, date, location, invitee and theme are all positively corroborated (e.g., at blocks 310-312), the 60% likelihood may be deemed relatively inaccurate. By contrast, if the same communication were instead deemed 95% likely to be event related at block 304, then the accuracy determined at block 314 may be higher.

At block 316, the system may generate feedback based on the accuracies determined at block 312 and/or 314. In some implementations, the feedback may include a direct indication of the accuracies themselves, e.g., as numeric values. In other implementations, the feedback may only include an indirect indication of the accuracies. At block 318, the generated feedback may be used to update a method of identifying event assumptions (block 302) and/or a method of determining a likelihood that a communication is event-related (block 304). For example, a machine classifier may be trained with the feedback at block 320. Additionally or alternatively, one or more rules may be modified based on the feedback at block 322.

Although not depicted in FIG. 3, in some implementations, the system may output, e.g., on a computer screen, information indicative of the accuracies determined at block 312 and/or 314 to a human reviewer, without providing any content of the communication to the human reviewer. This may prevent the human reviewer from being able to ascertain private information about a user.

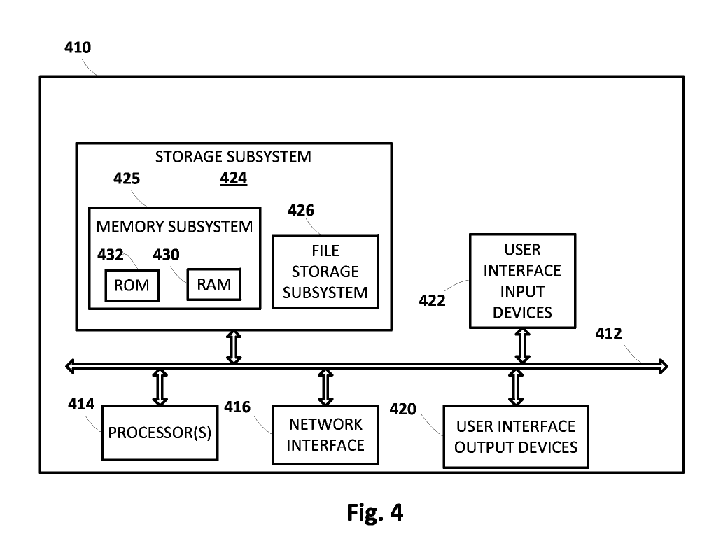

FIG. 4 is a block diagram of an example computer system 410. Computer system 410 typically includes at least one processor 414 which communicates with a number of peripheral devices via bus subsystem 412. These peripheral devices may include a storage subsystem 424, including, for example, a memory subsystem 425 and a file storage subsystem 426, user interface output devices 420, user interface input devices 422, and a network interface subsystem 416. The input and output devices allow user interaction with computer system 410. Network interface subsystem 416 provides an interface to outside networks and is coupled to corresponding interface devices in other computer systems.

User interface input devices 422 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into computer system 410 or onto a communication network.

User interface output devices 420 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computer system 410 to the user or to another machine or computer system.

Storage subsystem 424 stores programming and data constructs that provide the functionality of some or all of the modules described herein. For example, the storage subsystem 424 may include the logic to perform selected aspects of method 300, as well as one or more of the operations performed by email engine 120, text engine 122, calendar engine 124, social network engine 126, event assumption identification engine 130, scheduling signal engine 132, event assumption testing engine 134, and so forth.

These software modules are generally executed by processor 414 alone or in combination with other processors. Memory 425 used in the storage subsystem can include a number of memories including a main random access memory (RAM) 430 for storage of instructions and data during program execution and a read only memory (ROM) 432 in which fixed instructions are stored. A file storage subsystem 426 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 426 in the storage subsystem 424, or in other machines accessible by the processor(s) 414.

Bus subsystem 412 provides a mechanism for letting the various components and subsystems of computer system 410 communicate with each other as intended. Although bus subsystem 412 is shown schematically as a single bus, alternative implementations of the bus subsystem may use multiple busses.

Computer system 410 can be of varying types including a workstation, server, computing cluster, blade server, server farm, or any other data processing system or computing device. Due to the ever-changing nature of computers and networks, the description of computer system 410 depicted in FIG. 4 is intended only as a specific example for purposes of illustrating some implementations. Many other configurations of computer system 410 are possible having more or fewer components than the computer system depicted in FIG. 4.

In situations in which the systems described herein collect personal information about users, or may make use of personal information, the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used. In addition, training a machine learning model may be accomplished completely without human access to communications to or from users, and thus may be secure and private. The machine learning model also may be applied to new communications with no new human visibility into the contents of analyzed communication.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

1. A computer-implemented method, comprising:
analyzing, by a computing system using a machine learning classifier, a communication to or from a user to identify an event assumption;
determining, by the computing system based on one or more scheduling signals, an accuracy of the assumption, wherein the one or more scheduling signals include an actionable item created based on content of the communication, wherein the actionable item includes a textual segment of the communication containing an address of an event associated with the event assumption, wherein selection of the actionable item opens an application that is operable for real time navigation to the address; and
training, by the computing system, the machine learning classifier based at least in part on the accuracy.

2. The computer-implemented method of claim 1, further comprising determining, by the computing system based at least in part on the event assumption and using the machine learning classifier, a likelihood that the communication is event-related.

3. The computer-implemented method of claim 2, further comprising determining, by the computing system, an accuracy of the determined likelihood that the communication is event-related.

4. The computer-implemented method of claim 2, further comprising determining, by the computing system based on a count of corroborative scheduling signals, an accuracy of the determined likelihood that the communication is event-related.

5. The computer-implemented method of claim 1, wherein the one or more scheduling signals include a calendar entry created by the user or by another sender or recipient of the communication.

6. (canceled)

7. The computer-implemented method of claim 1, wherein the one or more scheduling signals include acceptance or rejection of a candidate calendar entry proposed to the user.

8. The computer-implemented method of claim 1, wherein the analyzing is performed by the computing system without providing any content of the communication to a human being.

9-16. (canceled)

17. A non-transitory computer-readable medium comprising instructions that, in response to execution of the instructions by a computing system, cause the computing system to perform operations comprising:
analyze a communication to or from a user using a machine learning classifier to identify an event assumption;
determine, based at least in part on the identified event assumption, a likelihood that the communication is event-related;
determine, based on one or more scheduling signals, an accuracy of the determined likelihood, wherein the one or more scheduling signals include an actionable item created based on content of the communication, wherein the actionable item includes a textual segment of the communication containing an address of an event associated with the event assumption, wherein selection of the actionable item opens an application that is operable for real time navigation to the address; and
train the machine learning classifier based at least in part on the accuracy.

18. The non-transitory computer-readable medium of claim 17, wherein the one or more scheduling signals include a calendar entry created by the user or by another sender or recipient of the communication.

19. The non-transitory computer-readable medium of claim 17, wherein the one or more scheduling signals include an event reminder or task created for or by the user.

20. The non-transitory computer-readable medium of claim 17, wherein the one or more scheduling signals include acceptance or rejection of a candidate calendar entry proposed to the user.
